(19) United States
(12) Patent Application Publication
(10) Pub. No.: US 2015/0112850 A1
(43) Pub. Date: Apr. 23, 2015

(54) AUTOMATIC FINANCIAL PRODUCT TRADING SYSTEM AND METHOD

(71) Applicants: KOREA ELECTRONICS TECHNOLOGY INSTITUTE, Seongnam-si (KR); SEOUL NATIONAL UNIVERSITY OF TECHNOLOGY CENTER FOR INDUSTRY COLLABORATION, Seoul (KR)

(72) Inventors: Hyedong JUNG, Seoul (KR); Seung Eun LEE, Seoul (KR)

(73) Assignees: KOREA ELECTRONICS TECHNOLOGY INSTITUTE, Seongnam-si (KR); SEOUL NATIONAL UNIVERSITY OF TECHNOLOGY CENTER FOR INDUSTRY COLLABORATION, Seoul (KR)

(21) Appl. No.: 14/521,696

(22) Filed: Oct. 23, 2014

(30) Foreign Application Priority Data
Oct. 23, 2013 (KR) 10-2013-0126575

(51) Int. Cl. G06Q 40/04

(52) U.S. Cl. CPC G06Q 40/04
USPC 705/37

(57) ABSTRACT

Provided are an automatic financial product trading system and method for automatically trading a financial product when the financial product satisfies a preset trading condition. Through an automatic ordering accelerator using separate hardware or an automatic ordering accelerator installed in a network card, rather than a main processor of a computer system, information input and output through a network card is collected and a financial product is quickly automatically traded.

### CROSS-REFERENCE TO RELATED APPLICATIONS

This application claims priority under 35 U.S.C. §119 to Korean Patent Application No. 10-2013-0126575, filed on Oct. 23, 2013, the disclosure of which is incorporated herein by reference in its entirety.

### TECHNICAL FIELD

The present invention relates to a system for automatically trading financial derivatives such as stocks, or the like, and more particularly, to an automatic financial product trading system and method for optimizing when to buy and when to sell financial products to automatically perform trading such that a gain is maximized.

### BACKGROUND

FIG. 1 is a block diagram illustrating a structure of a related art system for automatically trading stocks and financial derivatives. A trading system 120 and a user's computer system 100 are connected by a data communication network 110, and market information and order information are transmitted via the data communication network 110.

The automatic trading system is a system for automatically ordering and performing trading conclusion according to market situations based on strategies and restrictions previously determined by a user, and an automatic ordering program 101 realizing the system includes an application program conducted in an operating system of the computer system 100.

In the related art automatic trading system, market information from the data communication network 110 is delivered to a network card, the operating system, and the automatic ordering program 101, based on which trading is determined, and a determined order is delivered from the automatic ordering program 110 to the data communication network 110 via the operating system and the network card, and finally delivered to the trading system 120 to conduct the determined order.

Thus, in the related art automatic trading system, since the market information and order information need to pass through the data communication network 110 and the network card, the operating system, and the automatic ordering program 101 of the user's computer system 100, trading according to a predetermined trading condition may fail to be carried out due to a time delay.

### SUMMARY

Accordingly, the present invention provides an automatic financial product trading system and method for determining and requesting an order within a short time faster than determining an order by using market information from a data communication network, by shortening a time for automatically ordering based on market information using an automatic ordering accelerator.

In one general aspect, an automatic financial product trading system equipped with an automatic financial product trading program includes: a network support circuit configured to receive financial market information from a trading system; and an automatic ordering accelerator configured to collect the financial market information from the network support circuit, compare the financial market information with a preset trading condition, and transmit a trading order to the trading system through the network support circuit when the financial market information is identical to the preset trading condition.

The automatic ordering accelerator may be installed in a network card including the network support circuit.

The automatic ordering accelerator may perform the trading order by using separate hardware or a separate processor, rather than a main processor of the automatic financial product trading system.

When the financial market information is not identical to the preset trading condition, the automatic ordering accelerator may transmit the financial market information to the automatic financial product trading program.

After the automatic ordering accelerator transmits the trading order to the trading system, the automatic ordering accelerator may check a trading result based on the trading order and transmit the trading result to the automatic financial product trading program.

The automatic ordering accelerator may receive the preset trading condition through the automatic financial product trading program and store the received preset trading condition.

In another general aspect, a method for automatically trading financial products includes: receiving a preset trading condition through an automatic financial product trading program; collecting financial market information input and output through a network support circuit; comparing the financial market information with the preset trading condition; when the financial market information is identical to the preset trading condition, generating a trading order and transmitting the generated trading order to a trading system; when the financial market information is not identical to the preset trading condition, delivering the financial market information to the automatic financial product trading program and trading a financial product according to a trading condition set in the automatic financial product trading program; and receiving a financial product trading result based on the trading order from the trading system, and transmitting the received financial product trading result to the automatic financial product trading program.

Other features and aspects will be apparent from the following detailed description, the drawings, and the claims.

### BRIEF DESCRIPTION OF THE DRAWINGS

FIG. 1 is a block diagram illustrating a structure of the related art system for automatically trading financial products.

FIGS. 2 and 3 are block diagrams illustrating a structure of a system for automatically trading financial products according to an embodiment of the present invention.

FIG. 4 is a flow chart illustrating a process of a method for automatically trading financial products according to an embodiment of the present invention.

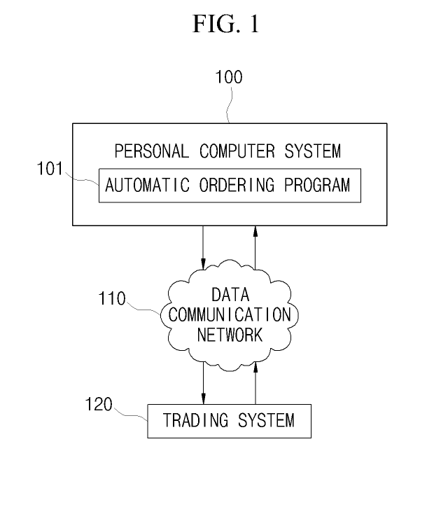

### DETAILED DESCRIPTION OF EMBODIMENTS

The advantages, features and aspects of the present invention will become apparent from the following description of the embodiments with reference to the accompanying drawings, which is set forth hereinafter. The present invention may, however, be embodied in different forms and should not be construed as limited to the embodiments set forth herein. Rather, these embodiments are provided so that this disclosure will be thorough and complete, and will fully convey the scope of the present invention to those skilled in the art.

The terms used herein are for the purpose of describing particular embodiments only and are not intended to be limiting of example embodiments. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. Hereinafter, embodiments of the present invention will be described in detail with reference to the accompanying drawings.

The present invention proposes an automatic financial product trading system and method for shortening a time for automatic ordering based on market information in automatically trading financial derivatives such as stocks, or the like.

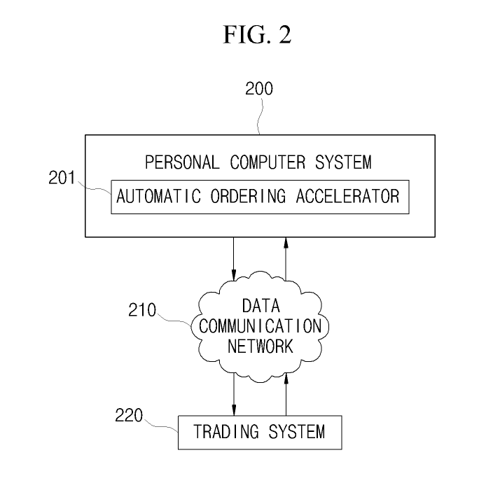

FIG. 2 is a block diagram illustrating a structure of an automatic financial product trading system according to an embodiment of the present invention.

An automatic ordering accelerator 201 of the automatic financial product trading system according to an embodiment of the present invention is implemented by hardware in a computer system 200. The automatic ordering accelerator 201 determines trading and requests an order by using separate hardware or a separate processor, rather than using a main processor of the computer system 200.

The automatic ordering accelerator 201 according to an embodiment of the present invention may include hardware and may be equipped with a processor, and thus, an automatic ordering program may be executed by the processor of the automatic ordering accelerator 201.

In an embodiment of the present invention, trading is determined by using data of a network as a transmission path of market and order information and an order is directly requested from a network, and a configuration of the automatic ordering accelerator 201 is not limited.

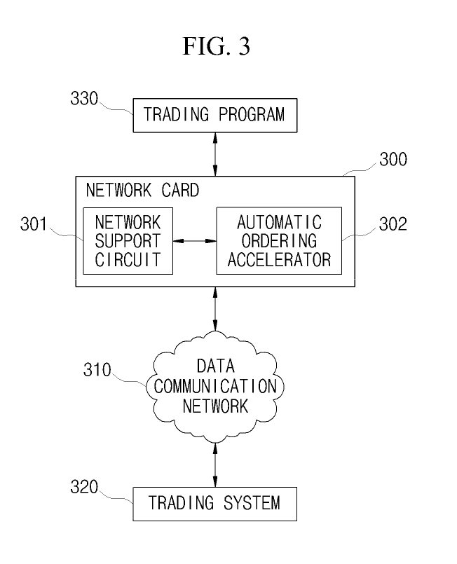

FIG. 3 is a block diagram illustrating a structure of an automatic financial product trading system according to another embodiment of the present invention.

An automatic ordering accelerator 302 is positioned in a network card 300 of a computer system to collect market information and determine automatic trading based on the collected market information. A determined order may directly be delivered to a trading system through a data communication network 310, thus shortening a time for determining trading and requesting an order.

A network support circuit 301 is an existing network support device for performing data communication, and the automatic ordering accelerator 302 according to an embodiment of the present invention collects market information by using input/output information from the network support circuit 301 and requests an order.

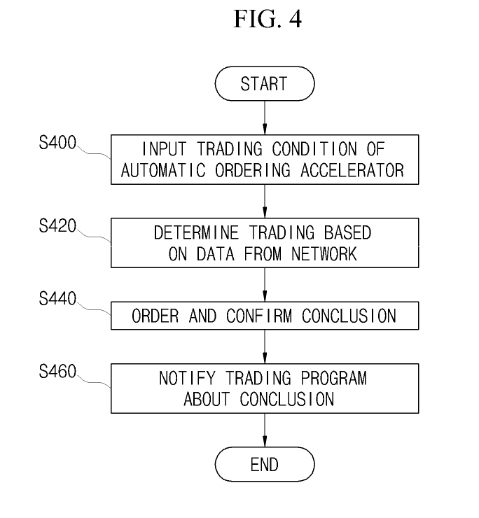

FIG. 4 is a flow chart illustrating a process of a method for automatically trading financial products according to an embodiment of the present invention.

The automatic financial product trading system receives a trading condition of an automatic ordering accelerator from a user in step S400 and stores information for the automatic ordering accelerator to determine trading and make an order.

The automatic ordering accelerator of the automatic financial product trading system analyzes data from a network based on the trading condition, compares market information with the trading condition to determine whether the market information is identical to the trading condition, and determines trading in step S420.

The automatic ordering accelerator of the automatic financial product trading system transmits the determined trading order to a trading system through a data communication network, and confirms a conclusion in step S440.

When the conclusion information is confirmed, the automatic ordering accelerator of the automatic financial product trading system notifies the user about the contract conclusion in step S460.

In an embodiment of the present invention, the automatic financial product trading system automatically makes a trading order with respect to financial products according to market information by using the automatic ordering accelerator which does not use a main processor of a computer or an automatic ordering accelerator positioned in a network card of a computer, financial products can be automatically traded more promptly, compared with the related art automatic trading system.

A number of exemplary embodiments have been described above. Nevertheless, it will be understood that various modifications may be made. For example, suitable results may be achieved if the described techniques are performed in a different order and/or if components in a described system, architecture, device, or circuit are combined in a different manner and/or replaced or supplemented by other components or their equivalents. Accordingly, other implementations are within the scope of the following claims.

What is claimed is:

1. An automatic financial product trading system equipped with an automatic financial product trading program, the automatic financial product trading system comprising:
a network support circuit configured to receive financial market information from a trading system; and
an automatic ordering accelerator configured to collect the financial market information from the network support circuit, compare the financial market information with a preset trading condition, and transmit a trading order to the trading system through the network support circuit when the financial market information is identical to the preset trading condition.

2. The automatic financial product trading system of claim 1, wherein the automatic ordering accelerator is installed in a network card including the network support circuit.

3. The automatic financial product trading system of claim 1, wherein the automatic ordering accelerator performs the trading order by using separate hardware or a separate processor, rather than a main processor of the automatic financial product trading system.

4. The automatic financial product trading system of claim 1, wherein when the financial market information is not identical to the preset trading condition, the automatic ordering accelerator transmits the financial market information to the automatic financial product trading program.

5. The automatic financial product trading system of claim 1, wherein after the automatic ordering accelerator transmits the trading order to the trading system, the automatic ordering accelerator checks a trading result based on the trading order and transmits the trading result to the automatic financial product trading program.

6. The automatic financial product trading system of claim 1, wherein the automatic ordering accelerator receives the preset trading condition through the automatic financial product trading program and stores the received preset trading condition.

7. A method for automatically trading financial products, the method comprising:
collecting financial market information input and output through a network support circuit;
comparing the financial market information with preset trading condition; and
when the financial market information is identical to the preset trading condition, generating a trading order and transmitting the generated trading order to a trading system.

8. The method of claim 7, further comprising:
when the financial market information is not identical to the preset trading condition, transmitting the financial market information to the automatic financial product trading program and trading a financial product according to a trading condition set in the automatic financial product trading program.

9. The method of claim 7, further comprising:
receiving the preset trading condition through the automatic financial product trading program.

10. The method of claim 7, further comprising:
receiving a financial product trading result based on the trading order from the trading system, and transmitting the received financial product trading result to the automatic financial product trading program.
